(19) United States
(12) Patent Application Publication
(10) Pub. No.: US 2007/0171925 A1
(43) Pub. Date: Jul. 26, 2007

(54) Multiplex superposed communication device

(75) Inventor: Yoshifumi Tanimoto, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/595,863

(22) Filed: Nov. 13, 2006

(30) Foreign Application Priority Data
Jan. 25, 2006 (JP) 2006-016334
Feb. 7, 2006 (JP) 2006-030337

(51) Int. Cl. H04L 12/56

(52) U.S. Cl. 370/401; 370/527

(57) ABSTRACT

A multiplex superposed communication device receives a data packet from a Local Area Network (LAN), analyzes the data packet, and extracts transmission destination information. A setting table includes a setting of a relation between the transmission destination information and multiplex signal channels. A signal channel to be used for relaying a communication signal is determined in accordance with the setting table. The communication signal is superposed on a power line and transmitted using the determined signal channel. When relaying data packets addressed to the same transmission destination, the same signal channel is used. Accordingly, each signal channel is reserved for each registered transmission destination.

### BACKGROUND OF THE INVENTION

1. Field of the Invention

The present invention relates to a communication terminal and a relay device which carry out multiplex superposed communication. More specifically, the present invention relates to setting of multiplexed signal channels.

2. Description of the Related Art

Various multiplex communication technologies are known for multiplexing one transmission channel. For example, the known multiplex communication technologies include the Frequency Division Multiplex (FDP), the Time Division Multiplex (TDM), and the Code Division Multiplex (CDM).

Power Line Communications (PLC) have been conventionally used as an infrastructure for multiplexing data. The PLC uses a power line installed within an office or home. Therefore, the PLC can efficiently establish a network.

In the multiplex communication, there is a limit on a number of signal channels that can be multiplexed in one communication line. Therefore, control has become important for determining which signal channel is to be assigned to which data. A quality of the multiplexed and superposed signal channels may differ for each signal channel. Thus, signal channels having a low error rate are assigned to high-priority communications.

However, when signal channels having a low error rate are assigned to high-priority communications, in case a large number of high-priority communications are generated, the high-quality signal channels can be assigned to only some of the communications. That is, when a plurality of high-priority communications are generated, the high-quality signal channels are basically assigned in an order of generation. As a result, the high-quality signal channels are assigned to just some of the communications. Furthermore, when all of the signal channels are occupied, a signal channel cannot be assigned even for high-priority communication.

A communication terminal executes various application programs using the multiplex communication. Application programs use unicast, multicast, broadcast or the like to carry out a communication process with another terminal connected to a communication line. In case of using the unicast, an important communication process is executed frequently with a specific communication terminal. Alternatively, in a teleconference system or the like, the multicast is used to reduce a burden imposed on the communication line and to smoothly carry out important business.

However, there is a limit on the multiplexing of a signal. When attempting to execute highly important communication with a specific terminal by the unicast, there may be a case in which a vacant signal channel cannot be obtained. Even when attempting to execute an application program using the multicast, if there is no vacant signal channel in the communication line, waiting time generates. Alternatively, a communication error generates. For example, when a plurality of communications with low-importance generate and the communication line is stressed, an important application program using the multicast may not operate.

### SUMMARY OF THE INVENTION

In order to overcome the problems described above, preferred embodiments of the present invention provide a multiplex superposed communication device which can assign multiplex signal channels in a balanced manner to high-priority communication or high-priority application program in superposed communication in which transmission channels are multiplexed.

According to an aspect of the present invention, a multiplex superposed communication device includes a first communication unit, a second communication unit, a setting table, a determining unit, and a relay unit. The first communication unit receives a data packet. The second communication unit carries out superposed communication by a plurality of multiplexed signal channels. The setting table stores a setting of a relation between information included in the data packet and the signal channels. The determining unit refers to the setting table in accordance with the information included in the data packet received by the first communication unit, and determines the signal channels of the second communication unit. The relay unit uses the signal channels determined by the determining unit to transmit the data packet, which has been received by the first communication unit, from the second communication unit.

According to another aspect of the present invention, a multiplex superposed communication device includes a communication unit, a management table, a determining unit, and a control unit. The communication unit carries out superposed communication using a plurality of multiplexed signal channels, and transmits and receives Internet Protocol (IP) packets. The management table stores a setting of a relation between an IP address of each transmission destination and the signal channels. The determining unit refers to the management table, and determines the signal channels according to each transmission destination of each of the IP packets. The control unit uses the determined signal channel to transmit the IP packet from the communication unit.

According to another aspect of the present invention, a multiplex superposed communication device includes a communication unit, communication application programs, a management table, a determining unit, and a control unit. The communication unit carries out superposed communication using a plurality of multiplexed signal channels, and transmits and receives IP packets. The communication application programs control transmission and reception of the IP packets. The management table stores a setting of a relation between the signal channels and the communication application programs. The determining unit refers to the management table, and determines the signal channels according to the communication application programs. The control unit uses the determined signal channels to transmit the IP packet from the communication unit.

According to the above-described multiplex superposed communication device, a data packet including specific information does not occupy the signal channels. That is, by previously registering the signal channels for the information stored in the setting table, the signal channels can be obtained for the registered information. As a result, the signal channels are not occupied by a data packet including certain data. Accordingly, the signal channels can be assigned in a balanced manner to data packets including high-priority information.

The signal channel used for transmitting a communication signal is determined according to transmission destination information included in the data packet. Accordingly, a signal channel can be obtained for a high-priority transmission destination, and the communication process can be carried out stably.

The signal channel used for transmitting a communication signal is determined in accordance with application program information included in the data packet. Accordingly, a signal channel can be obtained for a high-priority application program, and the communication process can be carried out stably.

When transmitting an IP packet by the communication application programs, the signal channel is determined according to the transmission destination of each IP packet transmitted by the communication application program. Accordingly, the signal channel can be obtained for each application program. For example, at least one signal channel can be reserved for at least one important application program. It is possible to prevent an important application program from not operating due to the signal channels being stressed by communication with low importance.

The signal channels are set for an address architecture such as a unicast IP address, a multicast IP address and a broadcast IP address. Accordingly, it is possible to prevent an important application program from not being able to use the multicast due to a band being stressed by unnecessary broadcast communication.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates a data packet relay device connected to a Local Area Network (LAN) and a power line according to a first preferred embodiment of the present invention.

FIG. 2 is a functional block diagram of the data packet relay device.

FIG. 3 illustrates a registration example of a communication signal management table.

FIG. 4 is a flowchart illustrating a flow of a relay process of a data packet.

FIG. 5 is a flowchart illustrating a process for determining a signal channel according to a transmission destination.

FIG. 6 is a flowchart illustrating a process for determining a signal channel according to a protocol.

FIG. 7 is a functional block diagram of a superposed communication terminal according to a second preferred embodiment of the present invention.

FIG. 8 illustrates a registration example of an IP address management table.

FIG. 9 illustrates an address architecture of an IP address used in multicast.

FIG. 10 is a flowchart illustrating a setting process of a signal channel when transmitting an IP packet.

FIG. 11 is a flowchart illustrating a process of a reception setting when the IP address management table has been changed.

FIG. 12 is a flowchart illustrating a process of a reception setting when an application program is activated.

### DETAILED DESCRIPTION OF PREFERRED EMBODIMENTS

### First Preferred Embodiment

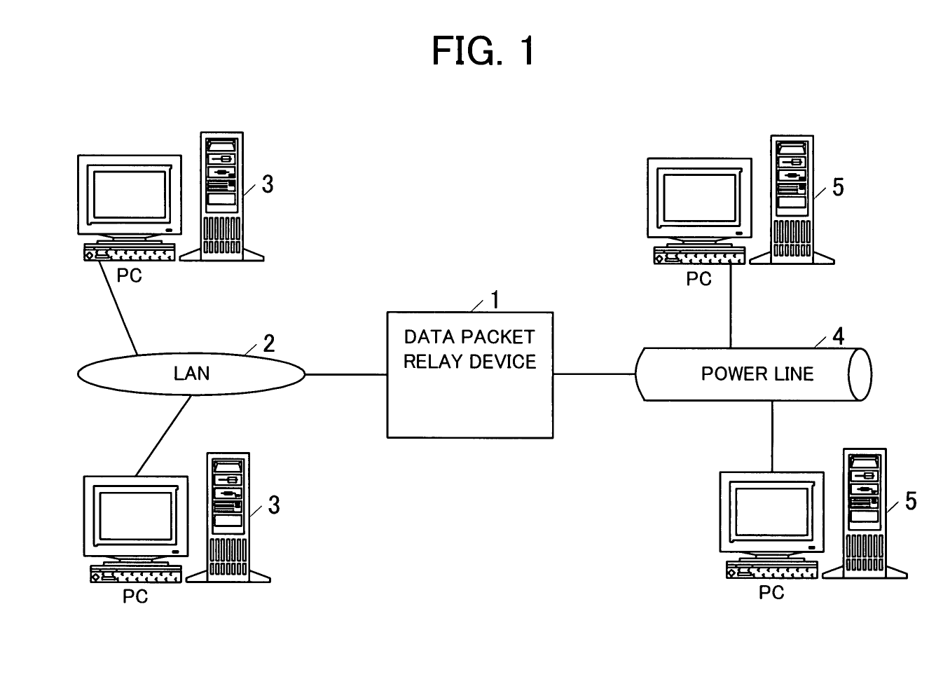

A description will be made of a first preferred embodiment of the present invention with reference to the drawings. As illustrated in FIG. 1, a data packet relay device 1 is connected to a LAN 2 and a power line 4. Further, the data packet relay device 1 is an example of a multiplex superposed communication device according to a preferred embodiment. A plurality of Personal Computers (PCs) 3 and 3, etc. are connected to the LAN 2. The data packet relay device 1 uses the Ethernet (registered trademark) for carrying out communication with the PCs 3 and 3, etc. A plurality of PCs 5 and 5, etc. are connected to the power line 4. The data packet relay device 1 carries out PLC with the PCs 5 and 5, etc. That is, the data packet relay device 1 carries out a process for relaying a data packet received from the LAN 2 to a power line communication network, and a process for relaying a communication signal received from the power line communication network to the LAN 2.

Further, in the present preferred embodiment, a description will be made of an example in which the data packet relay device 1 carries out a communication process with the PC 3 connected to the LAN 2 and the PC 5 connected to the power line 4. However, the data packet relay device 1 is also applicable to a communication process carried out with a terminal on another network connected via the LAN 2, and a terminal on another network connected via the power line 4.

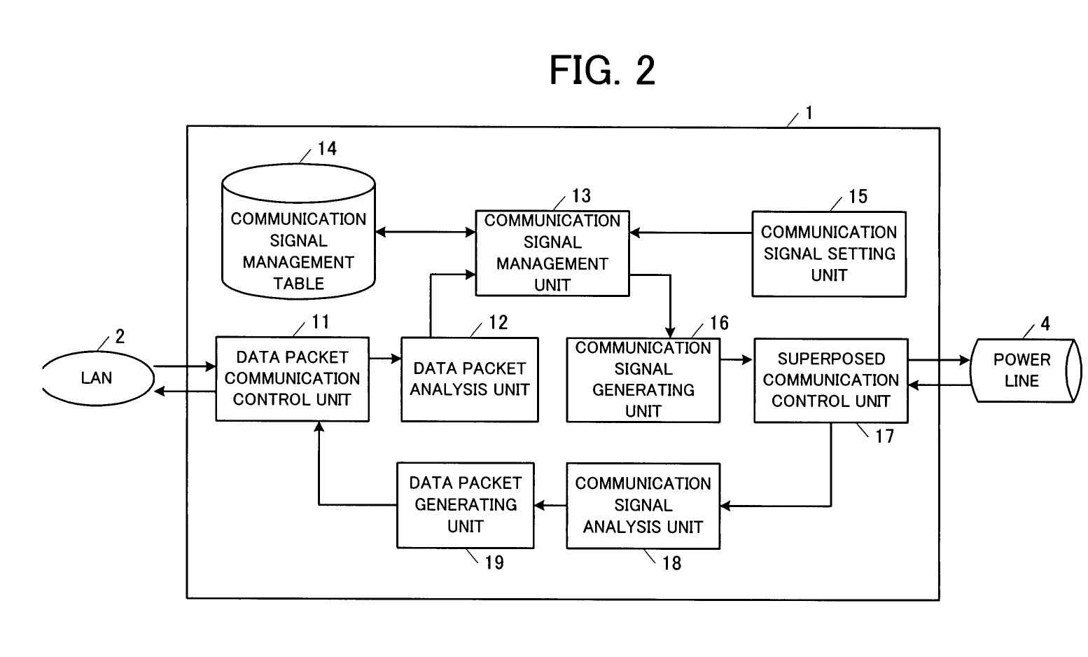

FIG. 2 is a functional block diagram of the data packet relay device 1. As illustrated in the drawing, the data packet relay device 1 includes a data packet communication control unit 11, a data packet analysis unit 12, a communication signal management unit 13, a communication signal management table 14, a communication signal setting unit 15, a communication signal generating unit 16, a superposed communication control unit 17, a communication signal analysis unit 18, and a data packet generating unit 19.

The data packet communication control unit 11 executes a process for receiving a data packet transmitted from the PC 3 connected to the LAN 2, and a process for transmitting a data packet to the PC 3.

The data packet analysis unit 12 analyzes the data packet received from the PC 3, and provides analyzed information to the communication signal management unit 13. The data packet received by the data packet communication control unit 11 is data constructed in accordance with a protocol format such as the Transmission Control Protocol/Internet Protocol (TCP/IP). Therefore, by analyzing a format of the received data packet, the data packet analysis unit 12 can distinguish and acquire data included in the data packet.

The communication signal management unit 13 is a processing unit which manages signal channels when relaying the data packet received from the LAN 2 to the power line 4. In the PLC, a plurality of signal channels are formed in one power line 4, and multiplex communication is carried out. In accordance with the setting contents of the communication signal management table 14, the communication signal management unit 13 determines and manages signal channels for carrying communication signals to be multiplexed.

The FDM, the TDM, and the CDM can be used as a multiplex method of the signal channels. When using the FDM, the communication signal management unit 13 manages a frequency band of signals to be multiplexed. When using the TDM, the communication signal management unit 13 manages a timeslot (time interval). When using the offset CDM, the communication signal management unit 13 manages a spread code.

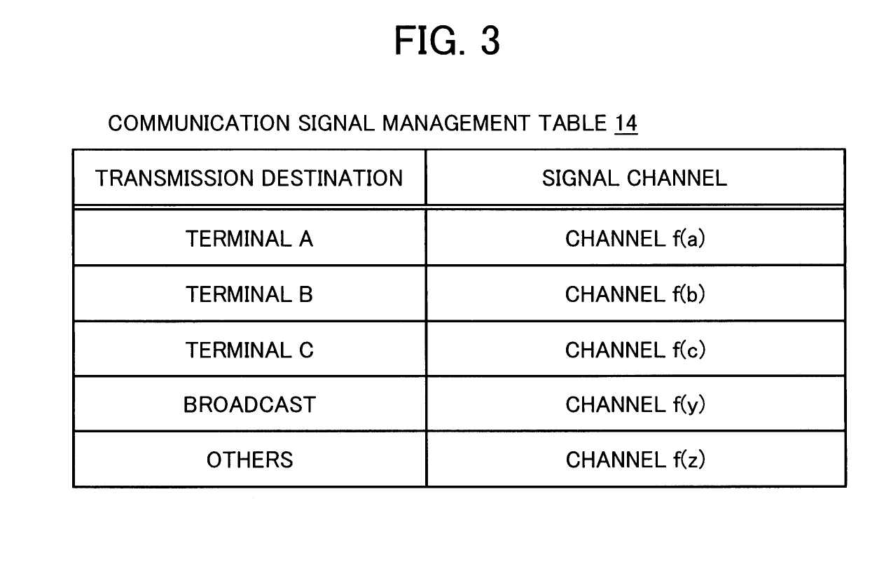

FIG. 3 is a chart illustrating a registration example of the communication signal management table 14. In the example illustrated in FIG. 3, a signal channel is set according to a transmission destination. The “SIGNAL CHANNEL” in FIG. 3 is a signal channel assigned to each transmission destination. As described above, the signal channel to be set differs according to a multiplex method. When using the FDM, a frequency band is assigned as the signal channel. When using the TDM, the timeslot is assigned as the signal channel. When using the CDM, the spread code is assigned as the signal channel.

In FIG. 3, a function f(x) is a function for determining a signal channel from an address of a transmission destination. For example, when the transmission destination is a terminal A, a signal channel f(a) can be calculated from an IP address (a) of the terminal A. In the same manner, a signal channel f(b) is calculated from an IP address (b) of a terminal B, and a signal channel f(c) is calculated from an IP address (c) of a terminal C. In case of a broadcast communication, (y) is reserved as an argument, and a signal channel f(y) is calculated. In other cases, i.e., when the transmission destination is not any one of the terminals A through C and when it is not a broadcast communication, (z) is reserved as an argument, and f(z) is calculated as a default signal channel.

Further, in the present preferred embodiment, a signal channel is determined by a calculation using a function f(x) for determining the signal channel. This facilitates the management of the signal channel. However, as another example, a fixed signal channel may be set in the communication signal management table 14.

The registration example illustrated in FIG. 3 is an example in which the signal channels are set in accordance with the information of the transmission destination. However, the setting method is not limited to such an example. For example, the signal channels may be set in accordance with application program information. For example, signal channels may be assigned preferentially to a protocol such as the Hyper Text Transfer Protocol (HTTP) and the Simple Mail Transfer Protocol (SMTP). That is, the signal channels may be set in accordance with the information included in the data packet analyzed by the data packet analysis unit 12. Any information may be used for setting the signal channels if the information is information included in the data packet.

The communication signal setting unit 15 is a processing unit for setting the communication signal management table 14. The communication signal setting unit 15 includes a user interface, and the user can set a transmission destination or the like to which a signal channel is preferentially assigned. For example, when reserving a signal channel for each transmission destination, the user registers a terminal name and an IP address of a terminal. The signal channel to be registered may be a fixed signal channel, or may be set to use the function f(x) as described above. Alternatively, when reserving a signal channel for each application program, the user registers a protocol name, a protocol port number or the like.

In the example illustrated in FIG. 3, the communication signal management table 14 includes a setting of transmission destinations to which the signal channels are preferentially assigned. That is, among the plurality of the PCs 5 and 5, etc. connected to the power line 4, the user sets to assign the signal channels preferentially to the terminals A through C. On the contrary, the communication signal management table 14 is set to assign a default signal channel f(z) to the other PC 5.

In accordance with the signal channel determined by the communication signal management unit 13, the communication signal generating unit 16 generates a communication signal to be relayed. The communication signal generating unit 16 generates a communication signal supporting the multiplex method and the assigned signal channel.

The superposed communication control unit 17 multiplexes and transmits the communication signal generated by the communication signal generating unit 16 to the power line 4 using the signal channel determined by the communication signal management unit 13. The superposed communication control unit 17 receives the communication signal superposed on the power line 4 from the PCs 5 and 5, etc. connected to the power line 4.

The communication signal analysis unit 18 analyzes the communication signal received by the superposed communication control unit 17. The communication signal analysis unit 18 analyzes the received communication signal in accordance with the multiplex method and the signal channel of the received signal. The communication signal analysis unit 18 provides the analysis result to the data packet generating unit 19. The data packet generating unit 19 restores the data packet in accordance with the analysis result of the communication signal analysis unit 18. That is, the superposed communication control unit 17 receives the communication signal superposed on a plurality of signal channels, and the data packet generating unit 19 restores the data packet from the multiplex signal. The data packet communication control unit 11 transmits the restored data packet to the LAN 2.

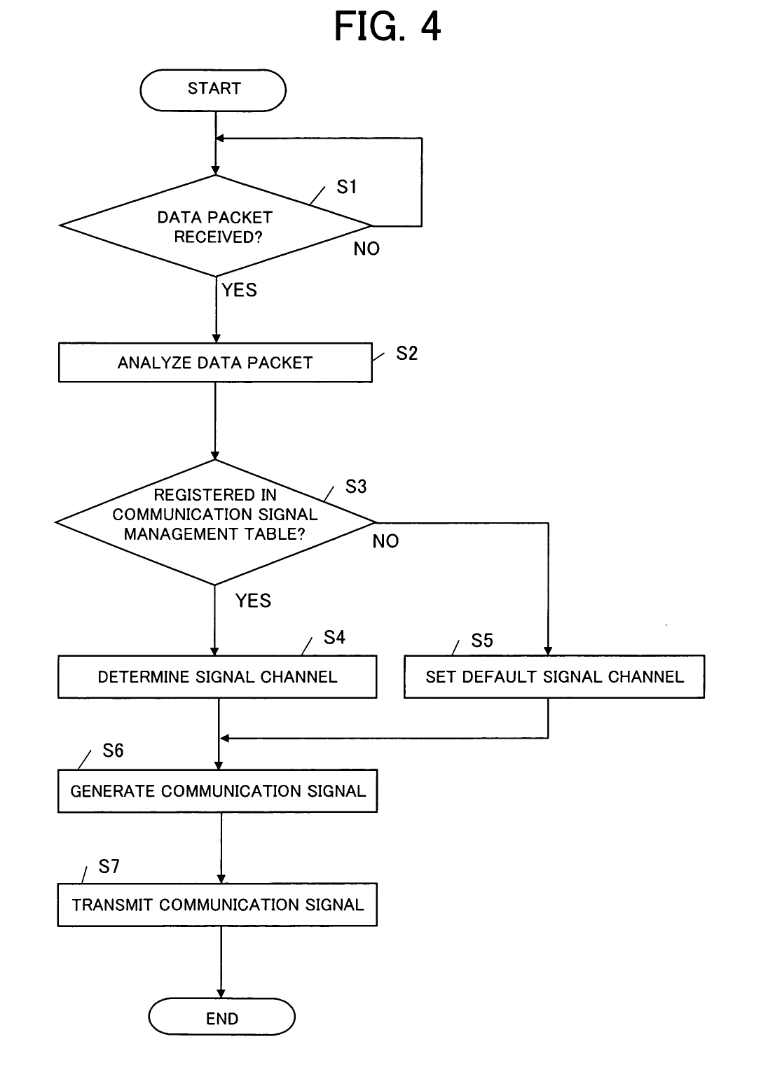

Next, a description will be made of a flow of a relay process of a data packet carried out by the data packet relay device 1 with reference to the flowcharts of FIG. 4 through FIG. 6.

First, a determination is carried out as to whether or not the data packet communication control unit 11 has received a data packet (step S1). When the data packet has been received, the data packet analysis unit 12 analyzes the received data packet (step S2). When the data packet analysis unit 12 provides the analysis result to the communication signal management unit 13, the communication signal management unit 13 refers to the communication signal management table 14, and determines whether or not the analyzed information is registered information (step S3).

When the analyzed information is registered in the communication signal management table 14 (step S3: YES), a signal channel of the data packet to be relayed is determined in accordance with the registered contents in the communication signal management table 14 (step S4). When the analyzed information is not registered in the communication signal management table 14 (step S3: NO), a default signal channel is set (step S5).

When the signal channel is determined, the communication signal generating unit 16 generates a communication signal (step S6). The superposed communication control unit 17 superposes and transmits the communication signal (step S7).

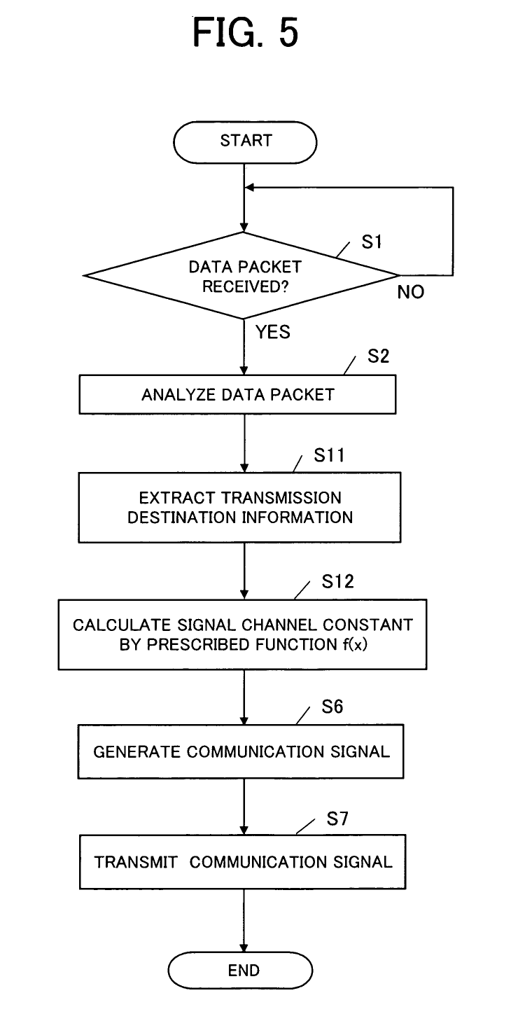

FIG. 5 is a flowchart illustrating details of a process of steps S3 through S5 in FIG. 4. Specifically, FIG. 5 is a flowchart of when a signal channel is set in accordance with transmission destination information. Steps S3 through S5 in FIG. 4 correspond to steps S11 and S12 in the flowchart of FIG. 5. The other steps in FIG. 5 are the same as the steps in the flowchart of FIG. 4.

The data packet analysis unit 12 analyzes the data packet (step S2), and extracts transmission destination information (step S11). The communication signal management unit 13 inputs the extracted transmission destination information in the function f (x), and determines the signal channel (step S12). That is, when the transmission destination information is the transmission destination reserved in the communication signal management table 14, the reserved signal channel is obtained by calculation. When the transmission destination information is not the transmission destination reserved in the communication signal management table 14, a default argument is provided to the function f(x), and the default signal channel is calculated.

In the example illustrated in FIG. 3, when the extracted transmission destination information is the terminals A through C, the IP addresses (a) through (c) are input to the function f(x), and the reserved signal channels f(a) through f(c) are assigned. When the extracted transmission destination information is not the terminals A through C and it is not a broadcast communication, a default argument (z) is input to the function f(x), and the default signal channel f(z) is assigned.

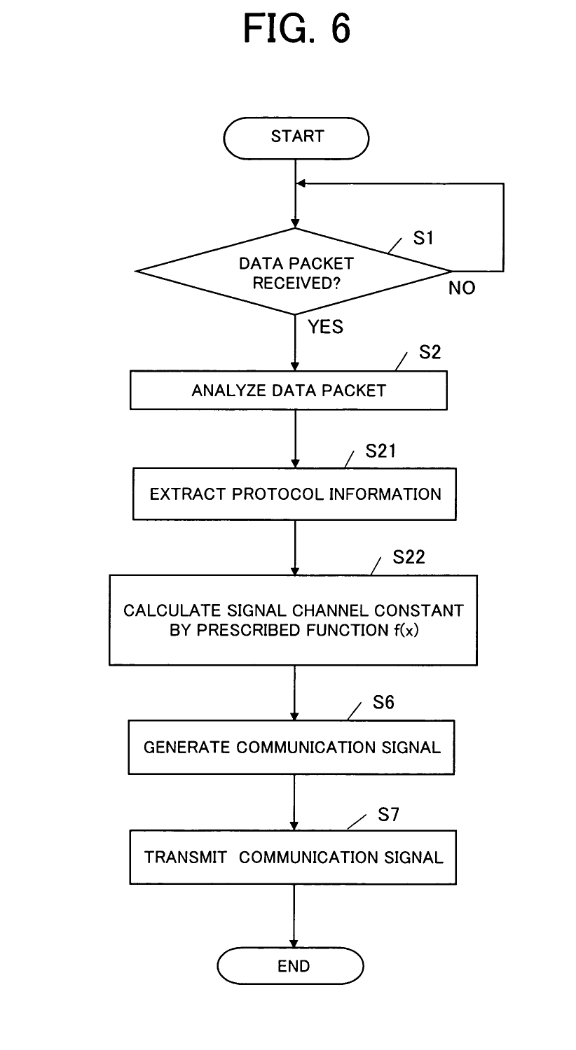

FIG. 6 is a flowchart illustrating another detailed example of the processes of steps S3 through S5 in FIG. 4. Specifically, FIG. 6 is a flowchart of when a signal channel is set in accordance with application program information. Steps S3 through S5 in FIG. 4 correspond to steps S21 and S22 in the flowchart of FIG. 6. The other steps in FIG. 6 are the same as the steps in FIG. 4.

The data packet analysis unit 12 analyzes the data packet (step S2), and extracts the application program information (step S21). Specifically, the data packet analysis unit 12 extracts protocol information included in the data packet. Then, the communication signal management unit 13 inputs the extracted protocol information in the function f(x), and determines the signal channel (step S22). That is, when the protocol information is reserved in the communication signal management table 14, the reserved signal channel is obtained by calculation. When the protocol information is not reserved in the communication signal management table 14, a default argument is provided to the function f(x), and the default signal channel is calculated.

For example, when the extracted protocol information is the HTTP and the HTTP is reserved in the communication signal management table 14, an HTTP protocol number h (for example, a port number may be used) is input, and a reserved signal channel f(h) is assigned. When the extracted protocol information is not registered, a default argument p is input in the function f(x), and a default signal channel f(p) is assigned.

As described above, the data packet relay device 1 of the present preferred embodiment preferentially assigns one signal channel to a previously registered transmission destination or a protocol. Accordingly, high-priority communication can be processed preferentially.

In the above-described preferred embodiment, one signal channel is assigned to the registered transmission destination or the protocol. Therefore, it is possible to prevent a large number of signal channels from being occupied by communication with a specific registered transmission destination and communication relating to a specific registered protocol.

That is, even when the terminal A is registered as a high-priority transmission destination, when a plurality of communications generate to be carried out with the terminal A, one signal channel is assigned. Therefore, it is possible to prevent the signal channels from being occupied by some of high-priority communications and a signal channel from not being assigned to other high-priority communications. For example, when the terminal A and the terminal B are registered as high-priority terminals, even when a plurality of communications generate to be carried out with the terminal A, only one signal channel is assigned to the terminal A. Accordingly, even when communication with the terminal B generates, a signal channel can be assigned instantaneously to the communication with the terminal B.

Further, when a plurality of high-priority registered communications are generated, the plurality of the communications may be processed using the assigned signal channel. For example, when a specific frequency band is assigned by the FDM, the assigned frequency band may be used to process the plurality of the communications by time-sharing. In the same manner, even when a plurality of communications generate using a default channel supported by a specific frequency band, a time-sharing process may be carried out.

As described above, in accordance with the information included in the data packet, the data packet relay device 1 determines a priority of the data packet to be relayed, and assigns the signal channel reserved for the high-priority communication. Without using an idea of an order in which the communications generate, a reserved signal channel is always obtained for the high-priority communication.

In the above-described preferred embodiment, the data packet relay device 1 receives a data packet from the Ethernet, and relays the received data packet to the power line 4. However, the network used by the data packet communication control unit 11 to transmit and receive a data packet is not limited to the Ethernet. For example, the network for transmitting and receiving the data packet may be an Asymmetric Digital Subscriber Line (ADSL) network or the like.

In the above-described preferred embodiment, the PLC has been described as an example of the superposed communication. As other examples, the superposed communication may be communication using an analog telephone line network, a coaxial cable, or wireless.

### Second Preferred Embodiment

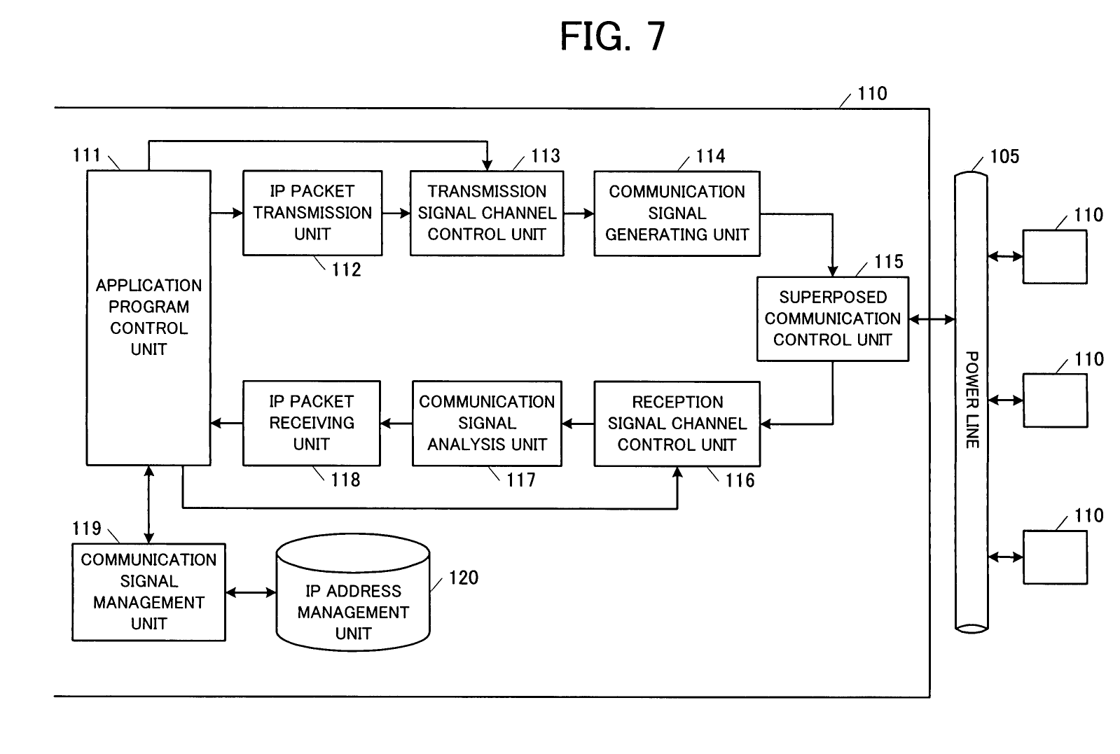

In the following, a description will be made of a second preferred embodiment of the present invention with reference to the drawings. FIG. 7 is a functional block diagram of a superposed communication terminal 110 as an example of a multiplex superposed communication device according to a preferred embodiment of the present invention. The superposed communication terminal 110 is a communication terminal connected to a power line 105, and transmits and receives an IP packet by superposing the IP packet on the power line 105. For example, the superposed communication terminal 110 may be connected to an existing power line network in an office to considerably reduce a burden required for a network construction.

An application program control unit 111 of the superposed communication terminal 110 is a processing unit relating to a communication process of an application program executed by the superposed communication terminal 110. Therefore, the application program control unit 111 is one of functions of the application programs executed by a Central Processing Unit (CPU) The superposed communication terminal 110 includes a CPU, a RAM, and a hard disk or the like in the same manner as a general PC. The superposed communication terminal 110 can execute various application programs stored in the hard disk or the like.

Some of the application programs executed by the superposed communication terminal 110 operate only by local, and some application programs executed by the superposed communication terminal 110 use a communication process. For example, in case of an application program for a teleconference system, an application program is executed while transmitting and receiving video image data or voice data to and from other terminals. Alternatively, in case of a World Wide Web (WEB) browser, a WEB content is downloaded from a designated WEB server.

As illustrated in FIG. 7, as processing units relating to transmission of an IP packet, the superposed communication terminal 110 includes an IP packet transmission unit 112, a transmission signal channel control unit 113, a communication signal generating unit 114, and a superposed communication control unit 115. As processing units relating to reception of an IP packet, the superposed communication terminal 110 includes a superposed communication control unit 115, a reception signal channel control unit 116, a communication signal analysis unit 117, and an IP packet receiving unit 118.

The IP packet transmission unit 112 is a processing unit for creating an IP packet from transmission data created by the application program control unit 111. The transmission signal channel control unit 113 is a processing unit for controlling a signal channel on which a transmission IP packet is superposed in accordance with a control of the application program control unit 111. The communication signal generating unit 114 is a processing unit for demodulating an IP packet according to a signal channel set by the transmission signal channel control unit 113 and generating a communication signal to be superposed on a power carrier wave.

The superposed communication control unit 115 carries out a process for superposing the communication signal, which has been generated by the communication signal generating unit 114, on the power carrier wave and outputting the generated communication signal to the power line 105. The superposed communication control unit 115 also carries out a process for receiving the communication signal superposed on the power carrier wave, and separating and extracting the communication signal from a superposed wave.

The reception signal channel control unit 116 is a processing unit for demodulating a communication signal according to a signal channel of the communication signal extracted by the superposed communication control unit 115. The communication signal analysis unit 117 acquires protocol information, data length, an error code or the like from the demodulated communication signal, and analyzes the communication signal. The IP packet receiving unit 118 is a processing unit for restoring and receiving an IP packet according to the analysis result of the communication signal by the communication signal analysis unit 117.

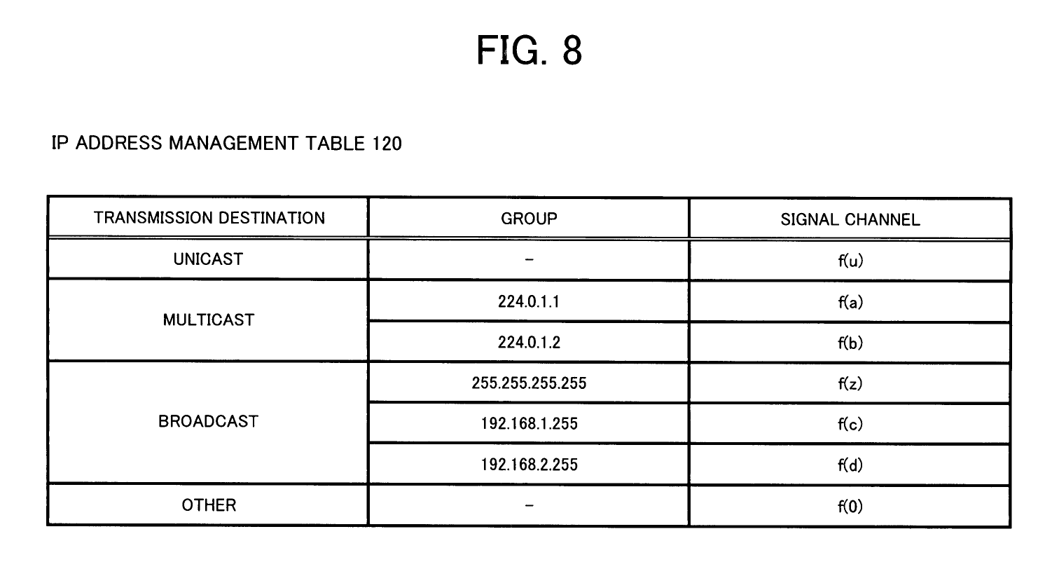

The communication signal management unit 119 carries out a retrieving process and an updating process of the data in an IP address management table 120. FIG. 8 illustrates an example of registered contents of the IP address management table 120.

The IP address management table 120 includes following three fields: “transmission destination”, “group”, and “signal channel”. The “transmission destination” field is an IP address architecture (or a classification of IP addresses) designated as a transmission destination when an application program carries out communication. For example, when the application program transmits an IP packet to a specific communication terminal, the classification of the “transmission destination” is unicast. When the application program transmits an IP packet to a plurality of communication terminals belonging to a specific group, the classification of the “transmission destination” is multicast. When the application program transmits an IP packet to all of the communication terminals, the classification of the “transmission destination” is broadcast. “OTHER” registered as the “transmission destination” is a default classification.

The “group” field is a field for specifying a specific group in the multicast and the broadcast. In the example illustrated in FIG. 8, as the multicast, an IP address “224.0.1.1” or “224.0.1.2” is registered. As the broadcast, an IP address “255.255.255.255”, “192.168.1.255” or “192.168.2.255” is registered.

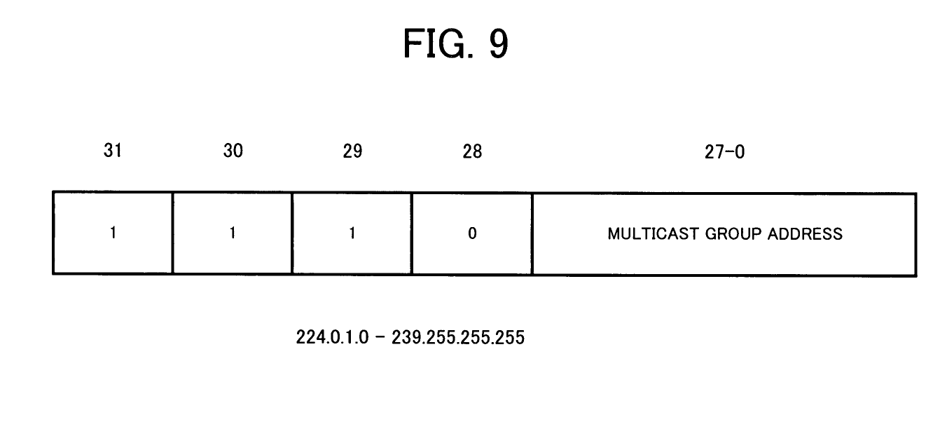

FIG. 9 illustrates an IP address architecture of the multicast. The multicast is an address of a class D of which high four bits are “1110”. A range of IP addresses that can be designated in the class D is “224.0.1.0” through “239.255.255.255”. In the example illustrated in FIG. 8, two group IP addresses for the multicast are registered from such a range. For example, the IP management table 120 includes a setting of a plurality of terminals to which an IP packet (for example, video image, voice) is transmitted by the multicast address “224.0.1.1” by an application program for a teleconference system. A receiving terminal also sets to receive an IP packet with the multicast address “224.0.1.1”.

The IP address “255.255.255.255” in the broadcast is an IP address for transmitting an IP packet to all terminals. An IP address “192.168.1.255” is an IP address for transmitting an IP packet to all terminals with a network address “192.168.1.0” (host address is lower eight bits). An IP address “192.168.2.255” is an IP address for transmitting an IP packet to all terminals with a network address “192.168.2.0” (host address is lower eight bits).

The “signal channel” field includes a registration of signal channels for each classification or each group. In the example illustrated in FIG. 8, the signal channel is expressed by a signal channel parameter x and a function f. However, in actuality, the signal channel parameter x is registered in the IP address management table 120.

The multiplex method includes various methods. For example, the multiplex method is the FDM, the TDM, and the CDM or the like. When using the FDM as the multiplex method, a signal channel constant f(x) is a frequency band assigned to the signal to be multiplexed. When using the TDM, the signal channel constant f(x) is a timeslot assigned to a signal to be multiplexed. When using the CDM, the signal channel constant f(x) is a spread code.

In the example illustrated in FIG. 8, in case of the unicast, a signal channel constant f(u) is set. In case of the multicast, signal channel constants f(a) and f(b) are set. In case of the broadcast, signal channel constants f(z), f(c), and f(d) are set. f(0) is set as other (default) signal channel constant.

The communication signal management unit 119 manages such an IP address management table 120. Other superposed communication terminals 110 connected to the power line 105 manage a table having the same contents as the above-described IP address management table 120. For example, a server may manage a master IP address management table 120, and by periodically referring to the master IP address management table 120, all superposed communication terminals 110 may manage the IP address management table 120 having the same contents.

Next, a description will be made of a flow of a process for generating a communication signal and setting a signal channel in the superposed communication terminal 110 configured as described above.

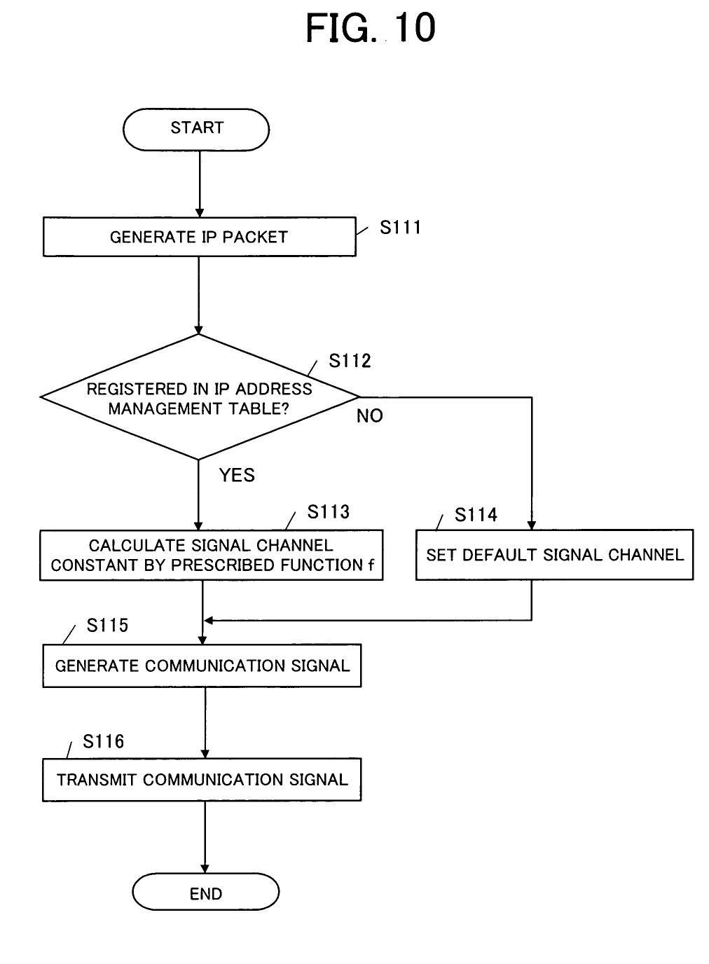

FIG. 10 is a flowchart illustrating a process when transmitting a data packet by an application program. When an application program is activated and the application program control unit 111 creates transmission data, the IP packet transmission unit 112 generates an IP packet in accordance with the transmission data (step S111).

Next, the application program control unit 111 provides information relating to a transmission destination, i.e. to which IP address the transmission data is to be transmitted by the application program, to the communication signal management unit 119. The communication signal management unit 119 searches the IP address management table 120 in accordance with the received information of the transmission destination, and provides the search result to the application program control unit 111.

As a result of the search, when the transmission destination of the IP packet to be transmitted by the application program is registered in the IP address management table 120 (step S112: YES), the application program control unit 111 provides a parameter x of the signal channel registered in the IP address management table 120 to the transmission signal channel control unit 113. The transmission signal channel control unit 113 calculates the signal channel constant f(x) using the provided parameter x of the signal channel and the function f (step S113). Meanwhile, when not registered in the IP address management table 120 (step S112: NO), the application program control unit 111 provides a parameter “0” of the signal channel to the transmission signal channel control unit 113. The transmission signal channel control unit 113 calculates a default signal channel constant f(0) using the received parameter “0” of the signal channel and the function f (step S114).

When the signal channel constant f(x) is calculated by the transmission signal channel control unit 113, the communication signal generating unit 114 demodulates the IP packet data and generates a communication signal in accordance with the signal channel constant f(x) (step S115). The superposed communication control unit 115 superposes the communication signal generated by the communication signal generating unit 114 on the signal channel designated by the signal channel constant f(x), and transmits the communication signal (step S116).

As described above, when the application program transmits an IP packet, a determination is carried out as to whether or not the IP address of the transmission destination is registered in the IP address management table 120. When the IP address of the transmission destination is registered, the reserved signal channel is used. When the IP address of the transmission destination is not registered, the reserved default signal channel is used. For example, when an unregistered group IP address is designated in the multicast, the default signal channel is used.

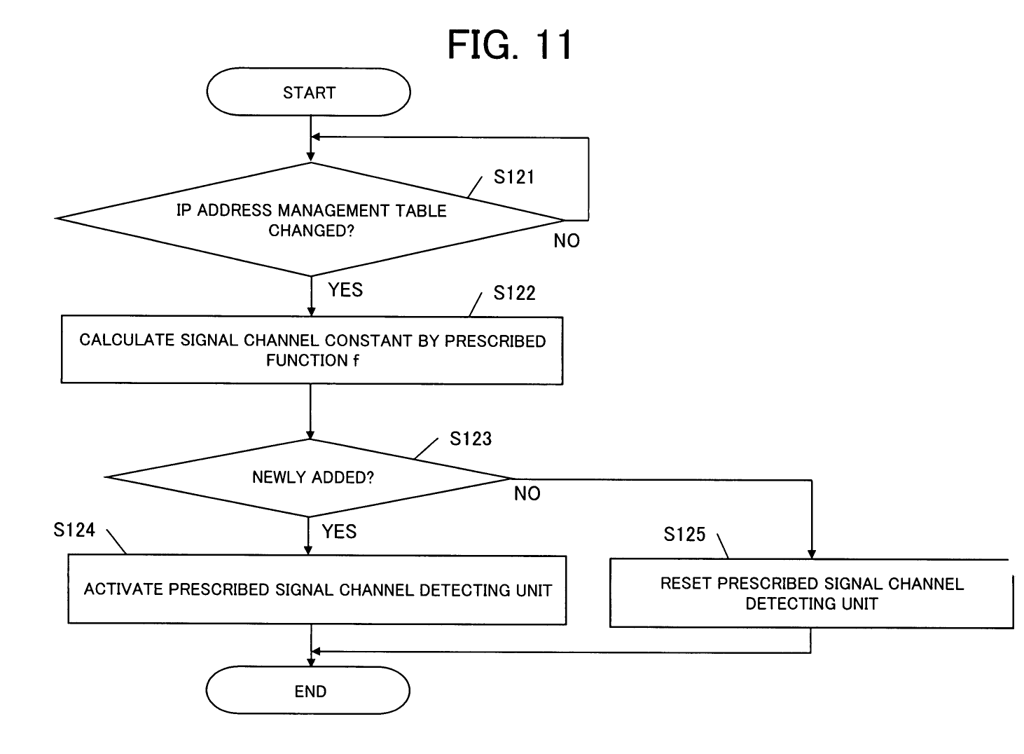

FIG. 11 is a flowchart illustrating a process for setting a signal channel for receiving an IP packet. The application program control unit 111 determines whether or not a changing process has been executed on the IP address management table 120 by the communication signal management unit 119 (step S121). When the changing process has been executed, the application program control unit 111 refers to a changed or a newly added record in the IP address management table 120. Then, a signal channel constant f(x) is calculated in accordance with the signal channel parameter x relating to the changed or the newly added transmission destination (step S122).

Then, a determination is carried out as to whether or not the changed content in the IP address management table 120 is a new addition of a record (step S123). When the changed content is a new addition, the reception signal channel control unit 116 activates a signal channel detecting unit associated with the calculated signal channel constant f(x) (step S124). Accordingly, the reception signal channel control unit 116 can demodulate a communication signal corresponding to the record that has been newly added to the IP address management table 120. That is, the signal channel detecting unit enables a filter to operate. Further, the filter can demodulate the communication signal superposed on the newly added signal channel.

Meanwhile, when the changed content of the IP address management table 120 is not a new addition of a record, that is, when a change is made to the already-registered record (step S123: NO), the reception signal channel control unit 116 resets (sets again) the already-activated signal channel detecting unit as a signal channel detecting unit corresponding to the calculated signal channel constant f(x) (step S125). Accordingly, the reception signal channel control unit 116 can demodulate the communication signal corresponding to the record that has been changed in the IP address management table 120.

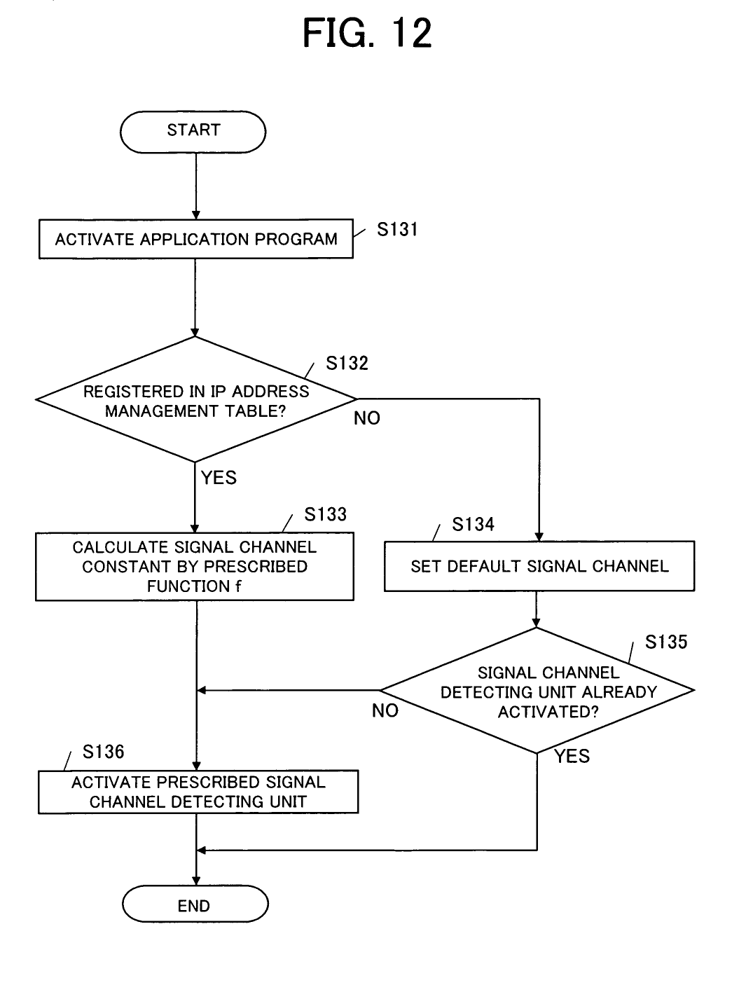

Next, with reference to FIG. 12, a description will be made of a flow of a process for setting a receiving channel when an application program is activated. In the superposed communication terminal 110, an application program for carrying out a communication process is activated (step S131) The application program control unit 111 determines whether or not an IP address or an IP address architecture, which is to be used by the application program for the communication process, is registered in the IP address management table 120 (step S132) When registered, the application program control unit 111 acquires the signal channel parameter x from the IP address management table 120, and calculates the signal channel constant f(x) based on the acquired signal channel parameter x (step S133). The reception signal channel control unit 116 activates the signal channel detecting unit corresponding to the calculated signal channel constant f(x) (step S136). Accordingly, the application program can demodulate the communication signal received by the superposed communication.

Meanwhile, when the IP address or the IP address architecture to be used by the application program for the communication process is not registered in the IP address management table 120 (step S132: NO), the application program control unit 111 calculates the signal channel constant f(0) based on the default parameter “0” (step S134). The reception signal channel control unit 116 determines whether or not the signal channel detecting unit corresponding to the calculated default signal channel constant f(0) is already activated (step S135). When the corresponding signal channel detecting unit is not activated, the application program control unit 111 activates the default signal channel detecting unit corresponding to the calculated signal channel constant f(0) (step S136). Accordingly, the application program becomes capable of demodulating the communication signal received by the superposed communication. When the default signal channel detecting unit is already activated (step S135: YES), the process ends.

For example, suppose that the application program is an application program for a teleconference system. When an application program for the teleconference is activated in each superposed communication terminal 110 that participates in the conference, each superposed communication terminal 110 receives a multicast IP packet including a video image and voice from another terminal. Therefore, since each superposed communication terminal 110 operates as a receiving terminal, each superposed communication terminal 110 executes the process illustrated in FIG. 12 to activate the signal channel detecting unit corresponding to the application program to be prepared for reception.

As described above, the superposed communication terminal 110 of the second preferred embodiment of the present invention determines the signal channel to be used for the PLC in accordance with the IP address or the IP address architecture determined by the application program. A relation between the IP address or the IP address architecture and the signal channel is previously reserved in the IP address management table 120. Accordingly, it is possible to avoid a situation in which there is no available signal channel for carrying out a multicast communication due to a plurality of unicast communications being carried out by a plurality of terminals 110 carrying out the PLC. Alternatively, it is possible to prevent an important application program from resulting in an execution error due to the band being stressed by the broadcast communication.

As described above, for example, the multicast is used for an application program or the like that distributes voice and a video image of a videoconference or a monitoring system or the like. If the band is occupied by another unicast communication or another broadcast communication, application programs do not operate smoothly. However, in the superposed communication system using the superposed communication terminal 110 of the present preferred embodiment, a signal channel is previously reserved for the IP address or the IP address architecture of the multicast, the broadcast, or the like. Therefore, an application program or the like using the multicast can be executed smoothly.

Some application programs use both the unicast communication and the multicast communication or the broadcast communication. Even when executing such an application program, since the signal channel corresponding to each IP address architecture is reserved, the application program can be executed smoothly.

As illustrated in FIG. 8, in the present preferred embodiment, the IP address architectures for all of the unicast, the multicast and the broadcast are registered in the IP address management table 120. The above-described example is just one of the examples. An IP address of any of these (for example, the unicast and the multicast) may be registered. For example, a plurality of terminals, which a band is desirable to be obtained as the unicast, may be registered.

In the above-described preferred embodiment, the PLC has been described as an example of the superposed communication. As other examples, the superposed communication may be communication using an analog telephone line network, a coaxial cable, or wireless.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A multiplex superposed communication device comprising:
a first communication unit which receives a data packet;
a second communication unit which carries out a superposed communication by a plurality of multiplexed signal channels;
a setting table which sets a relation between information included in the data packet and the signal channels;
a determining unit which refers to the setting table in accordance with the information included in the data packet received by the first communication unit, and determines the communication channels of the second communication unit; and
a relay unit which uses the signal channels determined by the determining unit to transmit from the second communication unit the data packet received by the first communication unit.

2. The multiplex superposed communication device according to claim 1, wherein in the setting table, transmission destination information included in the data packet is set by being associated with the signal channels.

3. The multiplex superposed communication device according to claim 1, wherein in the setting table, application information included in the data packet is set by being associated with the signal channels.

4. The multiplex superposed communication device according to claim 1, wherein the superposed communication is a power line carrier communication.

5. The multiplex superposed communication device according to claim 2, wherein the superposed communication is a power line carrier communication.

6. The multiplex superposed communication device according to claim 3, wherein the superposed communication is a power line carrier communication.

7. A multiplex superposed communication device comprising:
a communication unit which carries out a superposed communication using a plurality of multiplexed signal channels, and transmits and receives Internet protocol packets;
a management table in which the signal channels are set by being associated with transmission destination Internet protocol addresses;
a determining unit which refers to the management table, and determines the signal channels according to a transmission destination of the Internet protocol packets; and
a control unit which transmits the Internet protocol packets from the communication unit using the determined signal channels.

8. The multiplex superposed communication device according to claim 7, wherein in the management table, the signal channels are set by being associated with an address architecture of the transmission destination Internet protocol addresses.

9. The multiplex superposed communication device according to claim 8, wherein in the management table, the signal channels are set for the address architecture of at least two of an Internet protocol address for unicast, an Internet protocol address for multicast, and an Internet protocol address for broadcast.

10. A multiplex superposed communication device comprising:
a communication unit which carries out a superposed communication using a plurality of multiplexed signal channels, and transmits and receives Internet protocol packets;
communication applications which control the transmission and the reception of the Internet protocol packets;
a management table in which the signal channels are set by being associated with the communication applications;
a determining unit which refers to the management table and determines the signal channels according to the communication applications; and
a control unit which transmits the Internet protocol packets from the communication unit by using the determined signal channels.
